(19) United States
(12) Patent Application Publication
(10) Pub. No.: US 2012/0236071 A1
(43) Pub. Date: Sep. 20, 2012

(54) CLEANING APPARATUS AND LIQUID EJECTION APPARATUS AND CLEANING METHOD

(76) Inventor: Hiroshi INOUE, Kanagawa-ken (JP)

(21) Appl. No.: 13/484,659

(22) Filed: May 31, 2012

Related U.S. Application Data
(62) Division of application No. 12/709,061, filed on Feb. 19, 2010.

(30) Foreign Application Priority Data
Feb. 20, 2009 (JP) 2009-038512

(51) Int. Cl. B41J 2/165

(52) U.S. Cl. 347/28

(57) ABSTRACT

The cleaning apparatus cleans a nozzle surface of a liquid ejection head. The cleaning apparatus includes: a cleaning liquid supply device which supplies cleaning liquid to the nozzle surface while being not in contact with the nozzle surface; a liquid layer formation control device which causes the cleaning liquid supply device to supply a prescribed amount of the cleaning liquid to form a layer of the cleaning liquid that fills in a space between the cleaning liquid supply device and the nozzle surface; and a movement control device which controls a movement device so as to move the cleaning liquid supply device and the liquid ejection head relatively to each other at a relative speed in which a meniscus is not broken down, the meniscus being of the layer of the cleaning liquid in a portion of the layer of the cleaning liquid that makes contact with the nozzle surface.

This application is a Divisional of application Ser. No. 12/709,061, filed on Feb. 19, 2010 and claims priority of Patent Application No. 2009-038512 filed in Japan on Feb. 20, 2009, all of which are hereby expressly incorporated by reference into the present application.

### BACKGROUND OF THE INVENTION

1. Field of the Invention

The present invention relates to a cleaning apparatus, a liquid ejection apparatus and a cleaning method, and more particularly, to head cleaning technology for cleaning a nozzle surface (ejection surface) in a liquid ejection head based on an inkjet system.

2. Description of the Related Art

In an inkjet head, if dust or liquid of increased viscosity, or the like, adheres to the interior or the periphery of the nozzle apertures through which liquid droplets are ejected, then the ejection direction of the liquid droplets is deflected and displacement of the landing position occurs, and the nozzles become blocked, leading to ejection failures. In order to prevent or restore ejection defects of this kind, an inkjet recording apparatus having a mechanism for cleaning the nozzle surface is known.

Japanese Patent Application Publication No. 2005-096125 describes an inkjet recording apparatus which cleans the nozzle surface by filling ink into the gap between the cleaning plate and the nozzle plate, and then separating the cleaning plate. However, in this method, ink between the nozzle plate and the cleaning plate is collected to remove the ink droplets and dust adhering to the nozzle surface in a state where the cleaning plate is stationary, and therefore when used in a line head having a long dimension formed by joining together a plurality of head modules, cleaning takes a long time. On the other hand, supposing that a composition using a long cleaning plate is adopted, then the movement mechanism for same becomes large in size and there are significant cost increases. Moreover, since ink is used as the cleaning liquid, then the cleaning capability with respect to the nozzle surface is not necessarily sufficient. Furthermore, non-contact wiping which acts on the nozzle surface through a liquid (ink) is used, and hence there is low capability for removing adhering matter.

### SUMMARY OF THE INVENTION

The present invention has been contrived in view of these circumstances, an object thereof being to provide a cleaning apparatus for a liquid ejection head, a liquid ejection apparatus and a cleaning method using same, whereby the nozzle surface cleaning capability is improved, compatibility with a long head can be achieved readily and reduced space and lower costs can be achieved.

In order to attain the aforementioned object, the present invention is directed to a cleaning apparatus which cleans a nozzle surface of a liquid ejection head, the apparatus comprising: a cleaning liquid supply device which supplies cleaning liquid to the nozzle surface while being not in contact with the nozzle surface; a movement device which moves the cleaning liquid supply device and the liquid ejection head relatively to each other; a liquid layer formation control device which causes the cleaning liquid supply device to supply a prescribed amount of the cleaning liquid to form a layer of the cleaning liquid that fills in a space between the cleaning liquid supply device and the nozzle surface; and a movement control device which controls the movement device so as to move the cleaning liquid supply device and the liquid ejection head relatively to each other at a relative speed in which a meniscus is not broken down, the meniscus being of the layer of the cleaning liquid in a portion of the layer of the cleaning liquid that makes contact with the nozzle surface.

According to the present invention, by forming the cleaning liquid layer that fills in the space between the nozzle surface and the cleaning liquid supply device, and by causing relative movement of the cleaning liquid supply device and the liquid ejection head at the relative speed of a level that does not break down the meniscus of the cleaning liquid layer in the portion that contacts the nozzle surface, it is possible to clean the nozzle surface without leaving the cleaning liquid on the nozzle surface.

According to the present invention, it is possible to clean the whole of the nozzle surface while changing the cleaning position by relative movement of the cleaning liquid supply device and the nozzle surface, and therefore easy compatibility with a long head is possible and can be achieved while saving space and at low cost.

Moreover, by using the cleaning liquid for cleaning that is different than the liquid ejected from the liquid ejection head, it is possible to improve the cleaning capability.

Furthermore, in the cleaning step performed by the cleaning liquid layer according to the present invention, since no member for cleaning makes direct contact with the nozzle surface, then after a wiping operation by a wiping member, it is possible to remove the wiping trace of the wiping member by carrying out the relative movement operation through the cleaning liquid layer.

Alternatively, before the wiping operation by the wiping member, or independently of the carrying out of the wiping operation, it is also possible to remove adhering matter on the nozzle surface by carrying out the relative movement operation through the cleaning liquid layer according to the present invention.

According to the present invention, the nozzle surface cleaning effect is improved, ejection defects in the liquid ejection head can he prevented, and improvement in ejection reliability can be achieved.

### BRIEF DESCRIPTION OF THE DRAWINGS

FIG. 1 is a schematic drawing of an inkjet recording apparatus according to an embodiment of the present invention;

FIGS. 2A and 2B are plan view perspective diagrams showing an embodiment of the composition of a head;

FIG. 3 is a plan view perspective diagram showing a further embodiment of the structure of a head;

FIG. 4 is a cross-sectional diagram along line 4-4 in FIGS. 2A and 2B;

FIG. 5 is an enlarged view of a nozzle arrangement in the head in FIGS. 2A and 2B;

FIG. 6 is a perspective diagram of a maintenance unit arranged adjacently to an ink ejection unit;

FIG. 7 is a diagram showing the composition of a cleaning apparatus which is used in a maintenance unit according to an embodiment of the present invention;

FIG. 8 is a principal block diagram showing the system configuration of the inkjet recording apparatus;

FIG. 9 is a flowchart showing a head maintenance sequence in the inkjet recording apparatus according to a first embodiment;

FIG. 10 is a flowchart showing a head maintenance sequence in the inkjet recording apparatus according to a second embodiment;

FIG. 11 is a principal part schematic drawing of a cleaning apparatus according to a third embodiment which is used in a maintenance unit; and

FIGS. 12A and 12B are schematic drawings showing the action of a cleaning liquid application roller in the third embodiment.

### DETAILED DESCRIPTION OF THE PREFERRED EMBODIMENTS

### General Composition of Inkjet Recording Apparatus

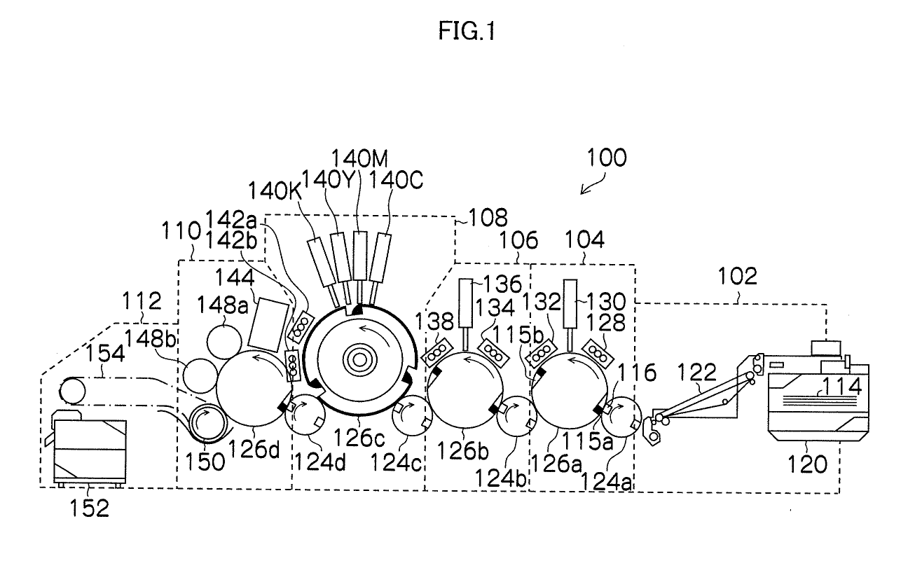

FIG. 1 is a schematic drawing of the composition of an inkjet recording apparatus 100 according to an embodiment of the present invention. The inkjet recording apparatus 100 adopts a pressure drum direct rendering system which directly deposits droplets of ink of a plurality of colors onto a recording medium (also referred to as “paper” for convenience) 114 held on a pressure drum 126c of an ink ejection unit 108 to form a desired color image, and is an on demand type image forming apparatus that uses the two liquid reaction (aggregation) system that uses the ink and treatment liquid (here, aggregation treatment liquid) to form images on the recording medium 114 of paper sheets.

The inkjet recording apparatus 100 principally includes: a paper supply unit 102, which supplies the recording medium 114; a permeation suppression agent deposition unit 104, which deposits permeation suppression agent on the recording medium 114; a treatment liquid deposition unit 106, which deposits treatment liquid onto the recording medium 114; the ink ejection unit 108, which ejects and deposits droplets of ink onto the recording medium 114; a fixing unit 110, which fixes an image recorded on the recording medium 114; and a paper output unit 112, which conveys and outputs the recording medium 114 on which an image has been formed.

Although not shown in FIG. 1, the inkjet recording apparatus 100 is also provided with a maintenance unit 70 (see FIG. 6) arranged at a side (in a direction perpendicular to the sheet of FIG. 1) of the ink ejection unit 108, for maintaining or cleaning ink ejection heads 140C, 140M, 140Y and 140K in the ink ejection unit 108. The maintenance unit 70 adopts a cleaning apparatus according to an embodiment of the present invention as below described in detail.

A paper supply platform 120 on which recording media 114 is stacked is provided in the paper supply unit 102. A feeder board 122 is connected to the front of the paper supply platform 120 (the left-hand side in FIG. 1), and the recording media 114 stacked on the paper supply platform 120 is supplied one sheet at a time, successively from the uppermost sheet, to the feeder board 122. The recording medium 114 which has been conveyed to the feeder board 122 is supplied through a transfer drum 124a to a pressure drum (permeation suppression agent drum) 126a of the permeation suppression agent deposition unit 104.

Holding hooks (grippers) 115a and 115b for holding the leading end portion of the recording medium 114 are arranged on the surface (circumferential surface) of the pressure drum 126a, and the recording medium 114 that has been transferred to the pressure drum 126a from the transfer drum 124a is conveyed in the direction of rotation (the counter-clockwise direction in FIG. 1) of the pressure drum 126a in a state where the leading end portion thereof is held by the holding hooks 115a and 115b and the medium adheres tightly to the surface of the pressure drum 126a (in other words, in a state where the medium is wrapped about the pressure drum 126a). A similar composition is also employed for the other pressure drums 126b to 126d, which are described hereinafter. A member 116 for transferring the leading end portion of the recording medium 114 to the holding hooks 115a and 115b of the pressure drum 126a is arranged on the surface (circumferential surface) of the transfer drum 124a. A similar composition is also employed for the other transfer drums 124b to 124d, which are described hereinafter.

### <Permeation Suppression Agent Deposition Unit>

The permeation suppression agent deposition unit 104 is provided with a paper preheating unit 128, a permeation suppression agent ejection head 130 and a permeation suppression agent drying unit 132 arranged respectively at positions facing the surface of the pressure drum 126a, in this order from the upstream side in terms of the direction of rotation of the pressure drum 126a (the counter-clockwise direction in FIG. 1).

The paper preheating unit 128 and the permeation suppression agent drying unit 132 are provided with hot air driers which can control the temperature and air blowing volume within a prescribed range. When the recording medium 114 held on the pressure drum 126a passes the positions facing the paper preheating unit 128 and the permeation suppression agent drying unit 132, hot air heated by the hot air driers is blown toward the surface of the recording medium 114.

The permeation suppression agent ejection head 130 ejects and deposits liquid containing a permeation suppression agent (the liquid also referred to simply as “permeation suppression agent”) onto the recording medium 114 held on the pressure drum 126a. The permeation suppression agent suppresses permeation of solvent (and organic solvent having affinity for the solvent) contained in the later-described treatment liquid and ink liquid into the recording medium 114. The permeation suppression agent is composed of resin particles dispersed as an emulsion in a solvent, or a resin dissolved in the solvent. Organic solvent or water is used as the solvent of the permeation suppression agent. Methyl ethyl ketone, petroleum, or the like may be desirably used as appropriate as the organic solvent of the permeation suppression agent.

In the present embodiment, an ejection system is employed in the device for depositing the permeation suppression agent on the surface of the recording medium 114, but the system is not limited to this, and it is also possible to use various other systems, such as a roller application system, a spray system, and the like. Such droplet ejection method can be suitably used because the permeation suppression agent can be deposited selectively only on portions where ink liquid is to be deposited and the neighboring portions. If the recording medium 114 does not easily curl, the deposition of the permeation suppression agent may be omitted.

The paper preheating unit 128 makes the temperature T₁ of the recording medium 114 higher than the lowest film formation temperature T_{f1} of the resin particles of the permeation suppression agent. Adjustment of the temperature T₁ may be carried out by the method of providing a heating element such as a heater or the like within the pressure drum 126a to heat the recording medium 114 from the bottom surface thereof, or the method of applying hot air to the upper surface of the recording medium 114, and the heating using an infrared heater to heat the recording medium 114 from the upper surface is used in the present embodiment. It is possible to use a combination of these.

The treatment liquid deposition unit 106 is arranged after the permeation suppression agent deposition unit 104. A transfer drum 124b is arranged between the pressure drum (permeation suppression agent drum) 126a of the permeation suppression agent deposition unit 104 and a pressure drum (treatment liquid drum) 126b of the treatment liquid deposition unit 106, so as to make contact with same. By adopting this structure, after the recording medium 114 which is held on the pressure drum 126a of the permeation suppression agent deposition unit 104 has been subjected to the deposition of the permeation suppression agent, the recording medium 114 is transferred through the transfer drum 124b to the pressure drum 126b of the treatment liquid deposition unit 106.

### <Treatment Liquid Deposition Unit>

The treatment liquid deposition unit 106 is provided with a paper preheating unit 134, a treatment liquid ejection head 136 and a treatment liquid drying unit 138 provided respectively at positions facing the surface of the pressure drum 126b, in this order from the upstream side in terms of the direction of rotation of the pressure drum 126b (the counter-clockwise direction in FIG. 1).

The paper preheating unit 134 uses a similar composition to the paper preheating unit 128 of the permeation suppression agent deposition unit 104, and the explanation is omitted here. Of course, it is also possible to employ a different composition. The treatment liquid ejection head 136 ejects and deposits the treatment liquid to the recording medium 114 held on the pressure drum 126b, and has a composition similar to the ink ejection heads 140C, 140M, 140Y and 140K of the later described ink ejection unit 108. The treatment liquid used in the present embodiment is an acidic liquid that has the action of aggregating the coloring materials contained in the inks that are ejected onto the recording medium 114 respectively from the ink ejection heads 140C, 140M, 140Y and 140K disposed in the ink ejection unit 108, which is arranged at a downstream stage.

The treatment liquid drying unit 138 is provided with a hot air drier which can control the temperature and air blowing volume within a prescribed range. When the recording medium 114 held on the pressure drum 126b passes the position facing the hot air drier of the treatment liquid drying unit 138, hot air heated by the hot air driers is blown toward the treatment liquid on the recording medium 114.

The heating temperature of the hot air drier is set to a temperature at which the treatment liquid which has been deposited on the recording medium 114 by the treatment liquid ejection head 136 disposed to the upstream side in terms of the direction of rotation of the pressure drum 126b is dried, and a solid or semi-solid aggregating treatment agent layer (a thin film layer of dried treatment liquid) is formed on the recording medium 114.

Reference here to “aggregating treatment agent layer in a solid state or a semi-solid state” includes a layer having a moisture content ratio of 0% to 70% as defined below. “Moisture content ratio”=“Weight per unit surface area of water contained in treatment liquid after drying (g/m²)”/“Weight per unit surface area of treatment liquid after drying (g/m²)”

Also, “aggregating treatment agent” refers not only to a solid or semi-solid substance, but in addition is used in the broader concept to include a liquid substance. In particular, liquid aggregating treatment agent that includes 70% or more solvent (content rate of solvent) is referred to as “aggregating treatment liquid”.

Experiment has shown that when the treatment liquid is dried until the solvent content in the treatment liquid becomes 70% or less, movement of coloring material is not conspicuous. Further, when the treatment liquid is dried until the solvent content in the treatment liquid becomes 50% or less, the level is so good that movement of coloring material can not be visually detected. Therefore, it has been confirmed that this is effective in preventing image degradation.

In this way, by drying the treatment liquid on the recording medium 114 to a solvent content of 70% or less (desirably 50% or less) so that a solid or semi-solid layer of aggregation treatment agent is formed on the recording medium 114, it is possible to prevent image degradation due to movement of coloring material.

### <Ink Ejection Unit>

The ink ejection unit 108 is arranged after the treatment liquid deposition unit 106. After the treatment liquid has been deposited onto the recording medium 114 held on the pressure drum 126b of the treatment liquid deposition unit 106, thereby forming a solid or semi-solid layer of aggregating treatment agent, the recording medium 114 is transferred through the transfer drum 124c to the pressure drum (image formation drum) 126c of the ink ejection unit 108.

The ink ejection unit 108 is provided with the ink ejection heads 140C, 140M, 140Y and 140K, which correspond respectively to four colors of ink, C (cyan), M (magenta), Y (yellow) and K (black), and solvent drying units 142a and 142b, which are arranged respectively at positions facing the surface of the pressure drum 126c, in this order from the upstream side in terms of the direction of rotation of the pressure drum 126c (the counter-clockwise direction in FIG. 1). By thus disposing the ink ejection heads 140C, 140M, 140Y and 140K on an arc about the periphery of the pressure drum 126c, it is possible to ensure landing position accuracy which is governed by the droplet ejection distance and to form a high-quality image.

An ink storing and loading unit (not shown) has ink tanks for storing the inks of the colors, and the ink tanks are connected to the corresponding ink ejection heads by means of prescribed channels. The inks are supplied from the ink tanks to the corresponding ink ejection heads 140C, 140M, 140Y and 140K, and droplets of the inks of the corresponding colors are ejected from the ink ejection heads 140C, 140M, 140Y and 140K toward the recording medium 114 in accordance with the image signal.

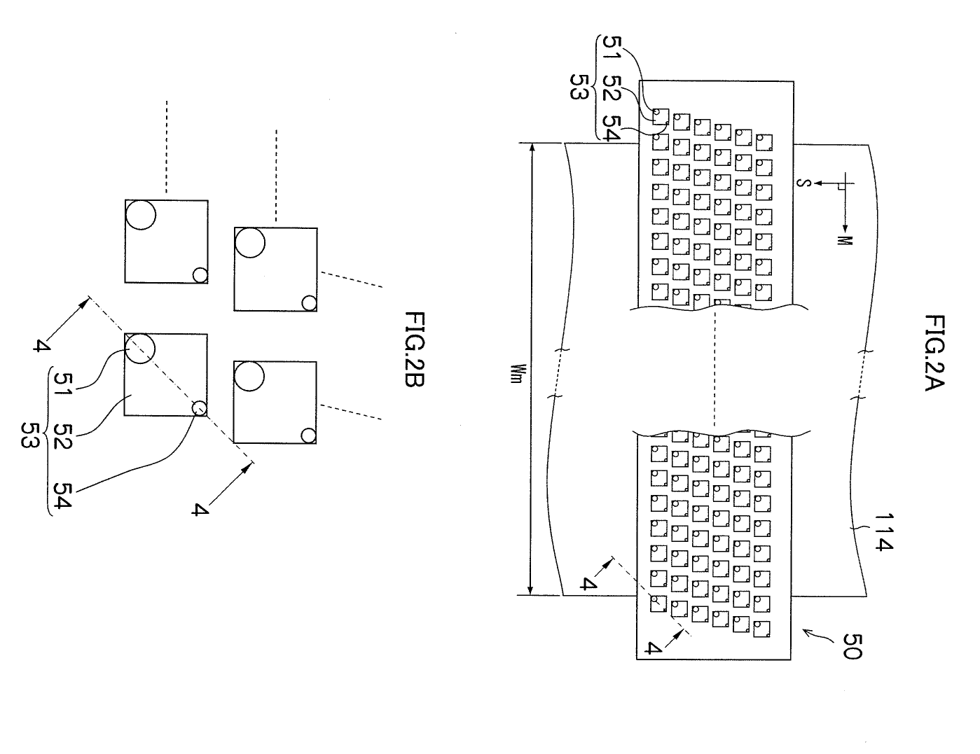

Each of the ink ejection heads 140C, 140M, 140Y and 140K is the full-line type head (see FIG. 2A) which has a length corresponding to a maximum width of an image forming region of the recording medium 114 held on the pressure drum 126c, and has the plurality of nozzles for ejecting ink (not illustrated in FIG. 1) arrayed on the ink ejection surface thereof over the full width of the image forming region of the recording medium 114. The ink ejection heads 140C, 140M, 140Y and 140K are fixed so as to extend in a direction that is perpendicular to the direction of rotation of the pressure drum 126c (the conveyance direction of the recording medium 114). According to the composition in which such full line heads having the nozzle rows which cover the full width of the image forming region of the recording medium 114 are provided for the respective colors of ink, it is possible to record an image on the image forming region of the recording medium 114 by performing just one operation of moving the recording medium 114 and the ink ejection heads 140C, 140M, 140Y and 140K relatively to each other (in other words, by one sub-scanning action) in the conveyance direction (the sub-scanning direction) by conveying the recording medium 114 in a fixed speed by the pressure drum 126c. This single-pass type image formation with such a full line type (page-wide) head can achieve a higher printing speed compared to a case of a multi-pass type image formation with a serial (shuttle) type of head which moves back and forth reciprocally in the direction (the main scanning direction) perpendicular to the conveyance direction of the recording medium (sub-scanning direction), and hence it is possible to improve the print productivity.

Although the configuration with the CMYK four colors is described in the present embodiment, combinations of the ink colors and the number of colors are not limited to those. As required, red (R), green (G) and blue (B) inks, light inks, dark inks and/or special color inks can be added. For example, a configuration in which ink heads for ejecting light-colored inks such as light cyan and light magenta are added is possible. Moreover, there are no particular restrictions of the sequence in which the heads of respective colors are arranged.

Each of the solvent drying units 142a and 142b has a composition similar to the paper preheating units 128 and 134, the permeation suppression agent drying unit 132, and the treatment liquid drying unit 138, which are described above. When ink droplets are deposited onto the aggregating treatment agent layer on the recording medium 114, an ink aggregate (coloring material aggregate) is formed on the recording medium 114, and furthermore, the ink solvent which has separated from the coloring material spreads and a liquid layer of dissolved aggregating treatment agent is formed. The solvent component (liquid component) left on the recording medium 114 in this way is a cause of curling of the recording medium 114 and also leads to deterioration of the image. Therefore, the solvent component is evaporated off and dried by the hot air driers of the solvent drying units 142a and 142b.

### <Fixing Unit>

The fixing unit 110 is arranged subsequent to the ink ejection unit 108. After the colored inks have been deposited onto the recording medium 114 held on the pressure drum 126c of the ink ejection unit 108 (i.e., after the image formation with the inks), the recording medium 114 is transferred through the transfer drum 124d to the pressure drum 126d of the fixing unit 110.

The fixing unit 110 is provided with an in-line determination unit 144, which reads in the print results of the ink ejection unit 108, and heating rollers 148a and 148b at positions facing the surface of the pressure drum 126d, in this order from the upstream side in terms of the direction of rotation of the pressure drum 126d (the counter-clockwise direction in FIG. 1). The in-line determination unit 144 includes an image sensor as a device reading the output images. The in-line determination unit 144 serves as a device that captures an image of the print result of the ink ejection unit 108 (the ink droplet deposition results of the ink ejection heads 140C, 140M, 140Y and 140K) and functions as a device for checking for nozzle blockages and other ejection defects and as a device for color measurement (colorimetry), on the basis of the captured droplet ejection image.

In this embodiment, a test pattern such as a color patch and line pattern is formed in the image recording area or non-image portion of the recording medium 114, this test pattern is read in by the in-line determination unit 144, and in-line determination is carried out, for instance, to acquire color information (colorimetry), determine density non-uniformities, judge the presence or absence of ejection abnormalities in the respective nozzles, and the like, on the basis of the reading results.

Each of the heating rollers 148a and 148b is a roller of which temperature can be controlled in a prescribed range (e.g., 100° C. to 180° C.). The image formed on the recording medium 114 is fixed while nipping the recording medium 114 between the pressure drum 126d and each of the heating rollers 148a and 148b to heat and press the recording medium 114. It is desirable that the heating temperature of the heating rollers 148a and 148b is set in accordance with the glass transition temperature of the polymer particles contained in the treatment liquid or the ink, for example.

The paper output unit 112 is arranged after the fixing unit 110. The paper output unit 112 is provided with a paper output drum 150, which receives the recording medium 114 on which the image has been fixed, a paper output platform 152, on which the recording media 114 are stacked, and a paper output chain 154 having a plurality of paper output grippers (not shown), which is spanned between a sprocket arranged on the paper output drum 150 and a sprocket arranged above the paper output platform 152.

### <Structure of Head>

Next, the structure of ink ejection heads 140C, 140M, 140Y and 140 K will be described. The respective ink ejection heads 140C, 140M, 140Y and 140 K have the same structure, and a reference numeral 50 is hereinafter designated to any of the heads.

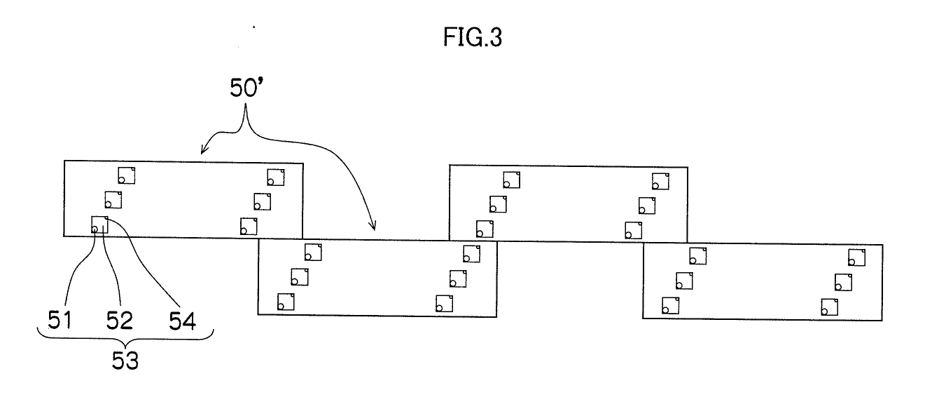

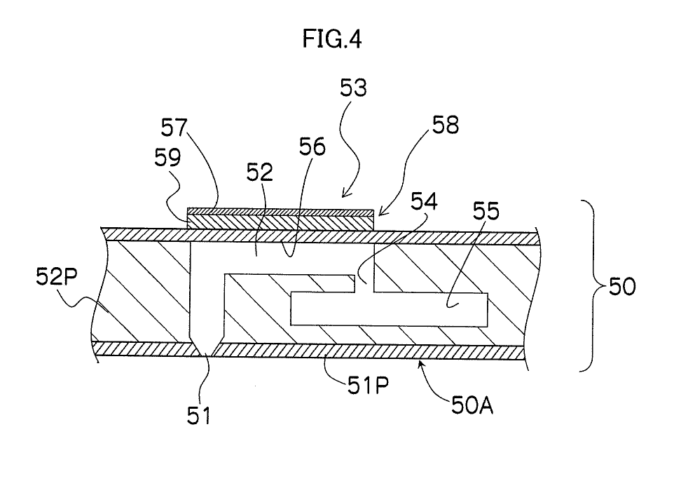

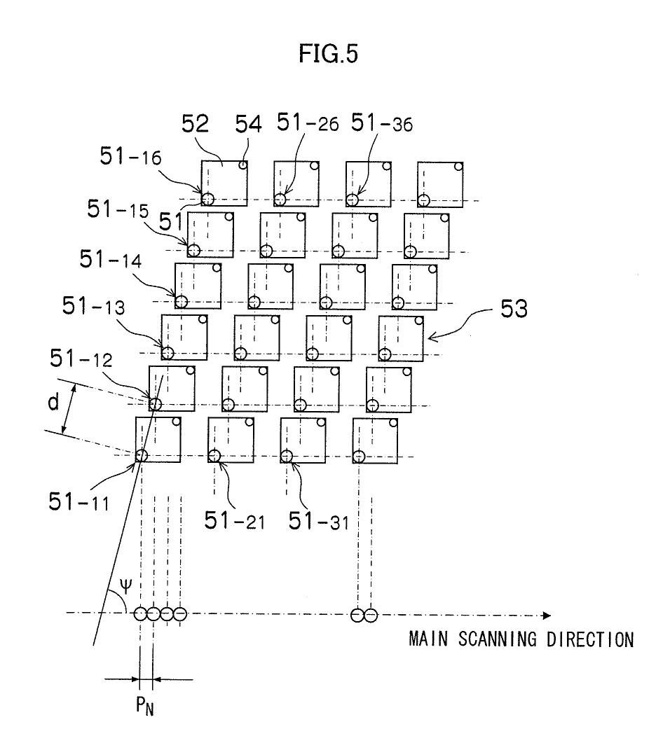

FIG. 2A is a plan perspective diagram illustrating an example of the structure of a head 50, and FIG. 2B is a partial enlarged diagram of same. Moreover, FIG. 3 is a planar perspective view illustrating another structural example of the head 50, and FIG. 4 is a cross-sectional diagram illustrating a liquid droplet ejection element for one channel being a recording element unit (an ink chamber unit corresponding to one nozzle 51) (a cross-sectional diagram along line 4-4 in FIGS. 2A and 2B).

As illustrated in FIGS. 2A and 2B, the head 50 according to the present embodiment has a structure in which a plurality of ink chamber units (liquid droplet ejection elements) 53, each having a nozzle 51 forming an ink droplet ejection aperture, a pressure chamber 52 corresponding to the nozzle 51, and the like, are disposed two-dimensionally in the form of a staggered matrix, and hence the effective nozzle interval (the projected nozzle pitch) as projected (orthographically-projected) in the lengthwise direction of the head (the direction perpendicular to the paper conveyance direction) is reduced and high nozzle density is achieved.

The mode of forming nozzle rows which have a length equal to or more than the entire width Wm of the recording medium 114 in a direction (direction indicated by arrow M: main scanning direction) substantially perpendicular to the paper conveyance direction (direction indicated by arrow S: sub-scanning direction) of the recording medium 114 is not limited to the embodiment described above. For example, instead of the configuration in FIG. 2A, as illustrated in FIG. 3, a line head having nozzle rows of a length corresponding to the entire width of the recording medium 114 can be formed by arranging and combining, in a staggered matrix, short head modules 50′ having a plurality of nozzles 51 arrayed in a two-dimensional fashion.

The pressure chamber 52 provided to each nozzle 51 has substantially a square planar shape (see FIGS. 2A and 2B), and has an outlet port for the nozzle 51 at one of diagonally opposite corners and an inlet port (supply port) 54 for receiving the supply of the ink at the other of the corners. The planar shape of the pressure chamber 52 is not limited to this embodiment and can be various shapes including quadrangle (rhombus, rectangle, etc.), pentagon, hexagon, other polygons, circle, and ellipse.

As illustrated in FIG. 4, the head 50 is configured by stacking and joining together a nozzle plate 51P, a flow channel plate 52P, a diaphragm 56, and the like. The nozzle plate 51P constitutes a nozzle surface (ink ejection surface) 50A of the head 50 and has formed therein the two-dimensionally arranged nozzles 51 communicating respectively to the pressure chambers 52.

The flow channel plate 52P constitutes lateral side wall parts of the pressure chamber 52 and serves as a flow channel formation member, which forms the supply port 54 as a limiting part (the narrowest part) of the individual supply channel leading the ink from a common flow channel 55 to the pressure chamber 52. FIG. 4 is simplified for the convenience of explanation, and the flow channel plate 52P may be structured by stacking one or more substrates.

The diaphragm 56 constituting one wall face (upper face in FIG. 4) of the pressure chamber 52 is made of an electrically-conductive material, such as stainless steel (SUS), or silicon (Si) with a nickel (Ni) conductive layer. The diaphragm 56 also serves as a common electrode of a plurality of actuators (piezoelectric elements) 58, which are disposed on the respective pressure chambers 52. The diaphragm 56 can be formed by a non-conductive material such as resin; and in this case, a common electrode layer made of a conductive material such as metal is formed on the surface of the diaphragm member.

A piezoelectric body 59 is arranged on a surface (upper side in FIG. 4) of the diaphragm 56 that is on the opposite side from the pressure chamber 52, so as to be in a position corresponding to the pressure chamber 52, and an individual electrode 57 is formed on an upper surface of the piezoelectric body 59 (surface on the other side of the surface contacting the diaphragm 56 serving as the common electrode). This individual electrode 57, the common electrode (served by the diaphragm 56 in this embodiment) opposing the individual electrode 57, and the piezoelectric body 59 interposed between these electrodes configure the piezoelectric element functioning as the actuator 58. Lead zirconate titanate, barium titanate, or other piezoelectric material is favorably used as the piezoelectric body 59.

Each pressure chamber 52 is connected through the supply port 54 to the common flow channel 55. The common flow channel 55 is connected to the ink tank (not shown), which is a base tank that supplies ink, and the ink supplied from the ink tank is delivered through the common flow channel 55 to the respective pressure chambers 52.

When a drive voltage is applied between the individual electrode 57 of the actuator 58 and the common electrode, the actuator 58 is deformed, the volume of the pressure chamber 52 is thereby changed, and the pressure in the pressure chamber 52 is thereby changed, so that the ink inside the pressure chamber 52 is ejected through the nozzle 51. When the displacement of the actuator 58 is returned to its original state after the ink is ejected, new ink is refilled in the pressure chamber 52 from the common flow channel 55 through the supply port 54.

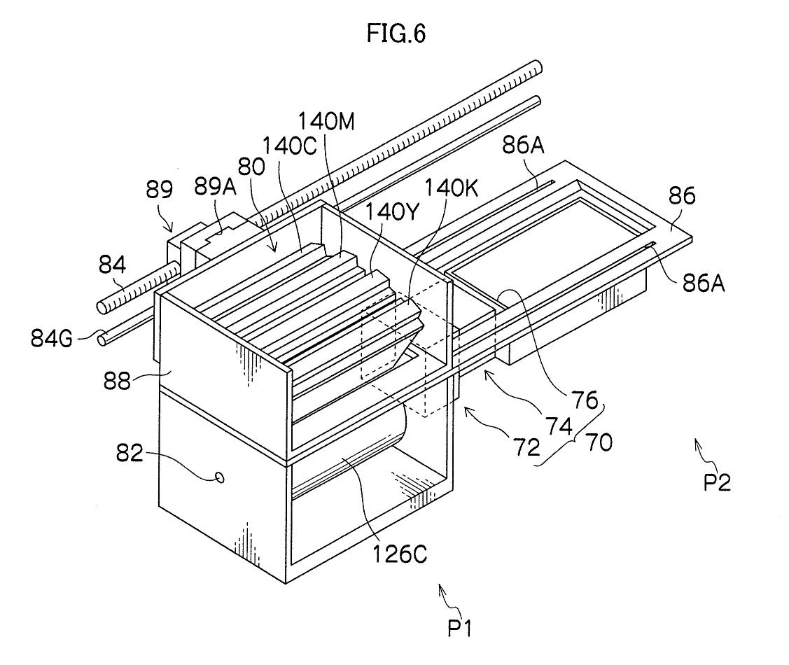

As illustrated in FIG. 5, by arranging the plurality of ink chamber units 53 having the above-described structure at a uniform pitch d in line with a direction forming an angle of ψ with respect to the main scanning direction, the pitch P_{N} of the nozzles projected so as to align in the main scanning direction is d×cos ψ, and hence the nozzles 51 can be regarded to be equivalent to those arranged linearly at a fixed pitch P_{N} along the main scanning direction.

When the nozzles arranged in a matrix such as that illustrated in FIG. 5 are driven, the nozzles 51-11, 51-12, 51-13, 51-14, 51-15 and 51-16 are treated as a block (additionally; the nozzles 51-21, 51-22, . . . , 51-26 are treated as another block; the nozzles 51-31, 51-32, . . . , 51-36 are treated as another block; . . . ); and one line is printed in the width direction of the recording medium 114 by sequentially driving the nozzles 51-11, 51-12, . . . , 51-16 in accordance with the conveyance velocity of the recording medium 114.

On the other hand, the printing along the sub-scanning direction is carried out by repeatedly performing, in the recording medium conveyance direction, printing of one line (a line formed of a row of dots, or a line formed of a plurality of rows of dots) formed by the main scanning.

In implementing the present invention, the mode of arrangement of the nozzles 51 in the head 50 is not limited in particular. For example, instead of the matrix arrangement as described in FIGS. 2A and 2B, it is also possible to use a single linear arrangement, a V-shaped nozzle arrangement, or an undulating nozzle arrangement, such as zigzag configuration (W-shape arrangement), which repeats units of V-shaped nozzle arrangements.

The present embodiment adopts the method in which an ink droplet is ejected by deforming an actuator represented by a piezoelectric element, but the method for ejecting ink is not limited in particular. Instead of such a piezo jet method, various methods can be adopted, such as a thermal jet method in which an ink droplet is ejected by a pressure caused by a bubble generated by heating the ink with a heat generation body such as a heater.

### Description of Maintenance Unit

FIG. 6 is a perspective diagram of the maintenance unit 70 arranged adjacently to the ink ejection unit 108. As shown in FIG. 6, the maintenance unit 70 for carrying out maintenance operations with respect to the ink ejection heads 140C, 140M, 140Y and 140K is arranged on the outside of the pressure drum 126c, adjacently to the ink ejection unit 108 in the axial direction of the pressure drum 126c.

The maintenance unit 70 is provided with a wiping unit 72, a cleaning liquid application unit 74 and a nozzle cap 76, disposed in this order from the side near the pressure drum 126c.

A head unit 80 mounted with the ink ejection heads 140C, 140M, 140Y and 140K corresponding to the respective colors is engaged to a ball screw 84, which is disposed in parallel with the rotational axle 82 of the pressure drum 126c. A guide shaft 84G is disposed in parallel with the ball screw 84, on the lower side of the ball screw 84, and the head unit 80 engages slidably with the guide shaft 84G. A guide rail member 86 having guide grooves 86A, which guide the movement of the head unit 80, is disposed in parallel with the ball screw 84, on the lower side of the head unit 80.

The head unit 80 has a frame body 88, which integrally holds the ink ejection heads 140C, 140M, 140Y and 140K. Engaging parts (not shown) are projectingly formed on the lower surface of the frame body 88, and slidably engage with the guide grooves 86A, whereby the head unit 80 is able to move by being guided by the guide grooves 86A.

As shown in FIG. 6, the ball screw 84, the guide shaft 84G and the guide rail member 86 are arranged extending in the axial direction of the pressure drum 126c through a prescribed length, in such a manner that the head unit 80 can be moved from an image forming position P1 above the pressure drum 126c to a maintenance position P2 facing the nozzle cap 76.

The ball screw 84 is rotated by a driving device such as a motor (not shown), and due to this rotation, the head unit 80 is moved between the image forming position P1 and the maintenance position P2. Furthermore, the head unit 80 can be moved in a direction away from the pressure drum 126c or in a direction toward the pressure drum 126c, by means of an upward/downward movement mechanism (not shown).

The height of the head unit 80 with respect to the surface of the pressure drum 126c (namely, the clearance between the recording surface of the recording medium 114 and the respective ink ejection heads 140C, 140M, 140Y and 140K) is controlled in accordance with the thickness of the recording medium 114 used. Furthermore, if a jam, or the like, occurs during conveyance of the recording medium, then the head unit 80 can be moved upward in FIG. 6 and thereby withdrawn from the prescribed height position during image formation.

As shown in FIG. 6, a coupling portion 89 between the frame body 88 of the head unit 80 and the ball screw 84 and the guide shaft 84G employs a linearly movable engagement structure 89A, which guides the upward and downward movement of the head unit 80.

### First Embodiment of Cleaning Apparatus

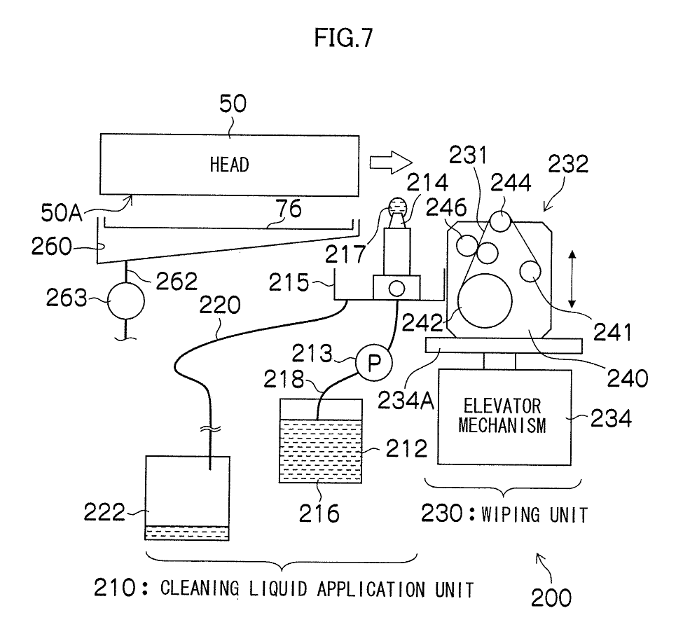

FIG. 7 is a diagram showing the composition of a cleaning apparatus 200, which is employed in the maintenance unit 70, according to an embodiment of the present invention. Here, the head 50 is described as the representative of the ink ejection heads 140C, 140M, 140Y and 140K.

The cleaning apparatus 200 is provided with a cleaning liquid application unit 210, which corresponds to the cleaning liquid application unit 74 in FIG. 6, and a wiping unit 230, which corresponds to the wiping unit 72 in FIG. 6. The cleaning liquid application unit 210 includes a cleaning liquid tank 212, a cleaning liquid pump 213, a cleaning liquid nozzle 214 and a used liquid receptacle 215. As the cleaning liquid 216, a special liquid having higher cleaning effects than the liquid (ink) that is ejected from the head 50 is used. For example, it is possible to use a cleaning liquid containing a solvent, such as DEGmBE (diethylene glycol monobutyl ether) as the cleaning liquid 216.

The ejection port of the cleaning liquid nozzle 214 faces upward so as to be able to create a pillar of cleaning liquid (cleaning liquid pillar 217) toward the nozzle surface 50A of the head 50, and the cleaning liquid nozzle 214 is disposed at a position in the vicinity of the nozzle surface 50A so as to guarantee a prescribed clearance for avoiding contact with the nozzle surface 50A when the cleaning liquid nozzle 214 faces the nozzle surface 50A.

The interval between the cleaning liquid nozzle 214 and the nozzle surface 50A when the cleaning liquid nozzle 214 faces the nozzle surface 50A is sufficient to be able to maintain a layer of cleaning liquid that makes contact with the nozzle surface 50A, and the interval is set to approximately 1 mm, for example. A suitable interval is designed in accordance with the properties (e.g., viscosity, surface tension) of the cleaning liquid, and the head movement speed, and the like.

Furthermore, although not shown in the drawings, a plurality of the cleaning liquid nozzles 214 are disposed along the sub-scanning direction, so as to be able to apply the cleaning liquid simultaneously over the breadth of the nozzle surface 50A in the breadthways direction of the head 50 (see FIG. 2A).

By driving the cleaning liquid pump 213, the cleaning liquid 216 is supplied from the cleaning liquid tank 212 to the cleaning liquid nozzles 214 through the supply channel 218. By suitably controlling the driving speed (ejection pressure) of the cleaning liquid pump 213, it is also possible to continuously spray the cleaning liquid from the cleaning liquid nozzle 214, and it is also possible to cause the cleaning liquid to seep out from the cleaning liquid nozzle 214 to form a liquid pillar having a meniscus (the convex upper surface of the cleaning liquid pillar 217) which bulges out from the cleaning liquid nozzle 214.

When the cleaning liquid is deposited onto the nozzle surface 50A before or during the wiping action by the wiping unit 72, the cleaning liquid is continuously sprayed from the cleaning liquid nozzles 214. On the other hand, in a rinsing step (hereinafter referred to as “finishing rinse”) for removing the trace of wiping after wiping and cleaning by the wiping unit 72, the cleaning liquid pillar 217 is formed from each of the cleaning liquid nozzles 214, and once this cleaning liquid pillar 217 has been formed, the head 50 is moved in the rightward direction in FIG. 7 so that the nozzle surface 50A of the head 50 and the meniscus of the cleaning liquid (the convex upper surface of the cleaning liquid pillar 217) are in contact with each other.

Here, if the head 50 is moved at high speed in a state where the meniscus of the cleaning liquid is in contact with the nozzle surface 50A, then the meniscus of the cleaning liquid breaks down and droplets of the cleaning liquid adhere to the nozzle surface 50A. Therefore, in the finishing rinse after the wiping and cleaning by using a web 231, the nozzle surface 50A is made to contact the meniscus of the cleaning liquid, and the head 50 is moved at low speed so as not to break the meniscus of the cleaning liquid layer. More specifically, the nozzle surface 50A of the head 50 is made to contact the cleaning liquid pillar 217, a cleaning liquid layer is then formed that fills in the gap between the nozzle surface 50A and the cleaning liquid nozzle 214, and the head 50 is moved horizontally while maintaining the meniscus of the cleaning liquid layer in the portion that contacts the nozzle surface 50A. By this means, the wiping trace having remained on the nozzle surface 50A is dissolved with the cleaning liquid and removed.

The cleaning liquid that has dropped from the cleaning liquid nozzles 214, for instance, due to the spraying of the cleaning liquid from the cleaning liquid nozzles 214, is recovered in the used liquid receptacle 215 and sent to a used liquid tank 222 through a tube 220. The liquid recovered into the used liquid tank 222 may be discarded or may be returned to the cleaning liquid tank 212 and reused.

The wiping unit 230 uses the web 231 made of cloth as a member that wipes the nozzle surface 50A. For the web 231, it is suitable to use, for example, a cloth material made of polyester or polypropylene fibers and having indentations in the surface.

The wiping unit 230 is provided with a web cartridge 232, which accommodates the web 231, and an elevator mechanism 234, which moves the web cartridge 232 upward and downward. The web cartridge 232 includes: a web feed roll 241 inside the frame body 240, a web take-up roll 242, a pressing roller 244, which presses the web 231 against the nozzle surface 50A of the head 50, and a pair of drive rollers 246, which drive and convey the web 231.

The web feed roll 241 is a roll of the unused web 231 that is wound in the form of the roll. A structure is adopted in which the web 231 paid out from the web feed roll 241 is wound up onto the pressing roller 244, passed through the pair of drive rollers 246, and taken up onto the web take-up roll 242.

A suitable tension is applied to the web 23 between the web feed roll 241 and the web take-up roll 242 by the pressing roller 244 and the drive rollers 246, and the web 231 is pressed against the nozzle surface 50A of the head 50 in the portion corresponding to the pressing roller 244.

The feed direction of the web 231 is the opposite direction to the direction of movement of the head 50 during wiping and cleaning (the rightward direction in FIG. 7), and by conjointly driving the drive rollers 246 and the shaft of the winding roll 242 in accordance with the movement of the head 50, a wiping action is carried out by the web 231 while the web 231 is wound up onto the web take-up roll 242.

The elevator mechanism 234 has an elevator platform 234A, which is capable of moving upward and downward in FIG. 7, and the web cartridge 232 is disposed on top of the elevator platform 234A. By controlling a drive device such as a motor (not shown) of the elevator mechanism 234, it is possible to control the contact/non-contact state of the web 231 with respect to the nozzle surface 50A.

The nozzle cap 76 is a cap for covering the nozzle surface 50A of the head 50, and may also be used as an ink receptacle when ink of increased viscosity is sucked from the nozzles 51 by setting the exterior of the nozzle surface 50A to a negative pressure, or a dummy jet is performed to eject ink in dummy from the nozzles 51 (this may also be referred to as preliminary ejection, purging, blank ejection, or the like). A waste liquid tray 260 is arranged on the lower side of the nozzle cap 76. A channel 262 and a pump 263 for sending the waste liquid to a waste ink tank (not shown) are connected to the bottom portion of the waste liquid tray 260.

### <Relationship Between Head Movement Speed and Finishing Rinse Effects>

Table 1 shows the results of a functional evaluation of the state of wiping residue left by the web and the residual cleaning liquid on the nozzle surface, at different head movement speeds.

TABLE 1

| | No finishing rinse | Finishing rinse carried out | | | |
|---|---|---|---|---|---|
| | Head movement speed (mm/sec) | | | | |
| | — | 10 | 20 | 50 | 100 |
| Wiping residue | Poor | Good | Good | Good | Good |
| Cleaning liquid residue | — | Good | Good | Fair | Poor |

In Table 1, “good” means a satisfactory cleaning effect. “Fair” means that some residual cleaning liquid is observed but this is of a level which is acceptable in practical terms. “Poor” means that cleaning is deficient.

The experiment shown in Table 1 as carried out as indicated below. Firstly, a wiping residue was generated on the nozzle surface 50A without finishing rinse, in other words, by carrying out a wiping operation of the nozzle surface 50A by means of the web 231 only.

Thereupon, the wiping residue could be eliminated by carrying out finishing rinse. When the movement speed of the head 50 is fast, then the cleaning liquid meniscus breaks down. The meniscus that thereby breaks down results small droplets adhering to the nozzle surface 50A. In this experiment, when the linear speed of the head was 100 mm/sec, then a large amount of cleaning liquid residue was observed, but no residue was observed at the linear speed of 20 mm/sec or lower.

According to Table 1, desirably, the head movement speed is 50 mm/sec or lower during the finishing rinse, and more desirably, 20 mm/sec or lower.

The lower limit value of the head movement speed (relative speed) should be a value greater than zero in order to achieve relative movement, and although a value infinitely close to zero is possible in theory, if this speed is too slow, then it is not practical, and therefore the movement speed (relative speed) is designed within a suitable practicable range.

### FIRST EXAMPLE

The wiping trace could be removed when the head movement speed was 20 mm/sec, the clearance between the head nozzle surface and the cleaning liquid nozzle (the gap between the top end of the cleaning liquid nozzle and the head nozzle surface) was 1 mm, the diameter of the cleaning liquid nozzle was 1 mm, and the finishing rinse was carried out using a cleaning liquid having a main component of DEGmBE.

### Second Embodiment of Cleaning Apparatus

In the first embodiment described above, in the finishing rinse, the cleaning liquid pillar 217 is formed from the cleaning liquid nozzle 214 to create a liquid pool between the cleaning liquid nozzle 214 and the nozzle surface 50A, and the head 50 is moved at a slow speed so as not to break down the meniscus. On the other hand, in the cleaning apparatus according to the second embodiment, it is possible to spout the cleaning liquid toward the nozzle surface 50A from the cleaning liquid nozzle 214 while the head 50 is moved.

In this case, the cleaning liquid is continuously supplied to the nozzle surface 50A, and the cleaning liquid of the meniscus that is in contact with the nozzle surface 50A is constantly replaced with new liquid, and therefore the cleaning capabilities of the cleaning liquid are maintained and further improvement of the cleaning capabilities can be achieved.

Even in a case where the cleaning liquid is made to continuously flow from the cleaning liquid nozzle 214 as in the second embodiment, desirably, the head 50 is moved at a speed of a level that does not break down the meniscus of the cleaning liquid layer formed between the nozzle surface 50A of the head 50 and the cleaning liquid nozzle 214, in the portion that contacts the nozzle surface 50A, and by this means, it is possible to clean the nozzle surface 50A without causing droplets of the cleaning liquid to remain adhering to the nozzle surface 50A.

Moreover, according to the second embodiment, since new cleaning liquid is continuously supplied to the nozzle surface 50A, then compared to the first embodiment, the cleaning liquid is not liable to run out during the movement of the head and application to a long head can be achieved even more easily.

### SECOND EXAMPLE

When the finishing rinse was carried out using the same conditions as in the first example for the parameters other than the flow speed of the cleaning liquid pump 213 described in FIG. 7 that was set to 100 ml/min, it was possible to remove wiping traces in a long head of 800 mm length.

### Description of Control System

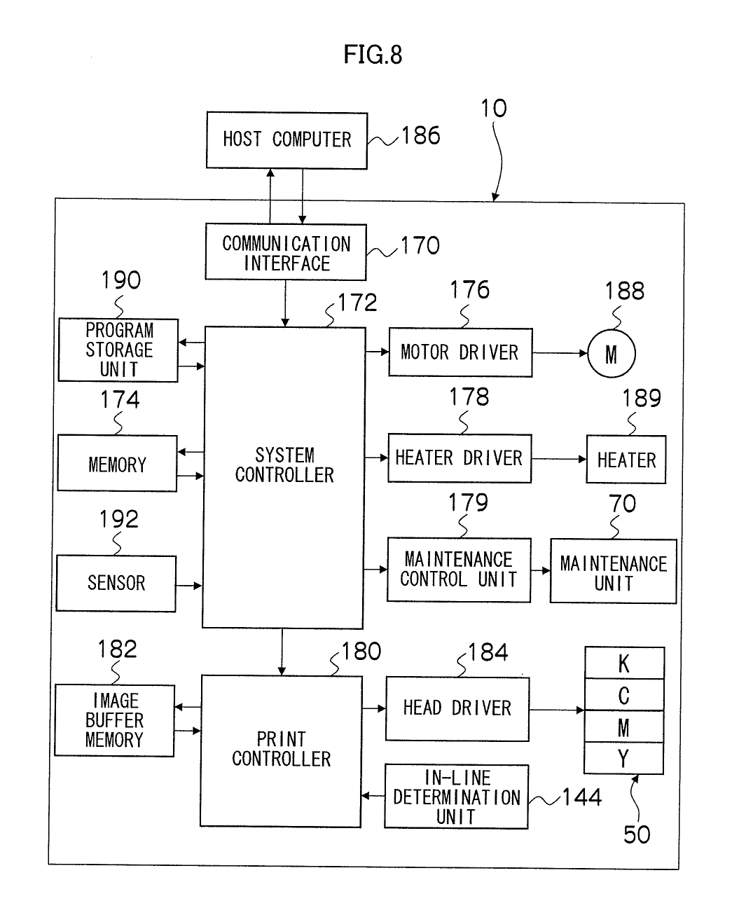

FIG. 8 is a block diagram of the main portion of a system configuration of the inkjet recording apparatus 100. The inkjet recording apparatus 100 includes a communication interface 170, a system controller 172, a memory 174, a motor driver 176, a heater driver 178, a maintenance control unit 179, a printing control unit 180, an image buffer memory 182, a head driver 184, a sensor 185, and a program storage unit 190.

The communication interface 170 is an interface unit, which functions as an image input device that receives image data sent from a host computer 186. A serial interface such as USB (Universal Serial Bus), IEEE 1394, Ethernet, and a wireless network, or a parallel interface such as Centronix can be applied as the communication interface 170. A buffer memory (not shown) may be installed in the part of the interface to increase the communication speed. The image data sent from the host computer 186 are introduced into the inkjet recording apparatus 100 through the communication interface 170 and temporarily stored in the memory 174.

The memory 174 is a storage device that temporarily stores the images inputted through the communication interface 170 and reads/writes the data via the system controller 172. The memory 174 is not limited to a memory composed of semiconductor elements and may use a magnetic medium such as a hard disk.

The system controller 172 includes a central processing unit (CPU) and a peripheral circuitry thereof, functions as a control device that controls the entire inkjet recording apparatus 100 according to a predetermined program, and also functions as an operational unit that performs various computations. Thus, the system controller 172 controls various units such as the communication interface 170, the memory 174, the motor driver 176, and the heater driver 178, performs communication control with the host computer 186, performs read/write control of the memory 174, and also generates control signals for controlling various units such as a motor 188 and a heater 189 in the recording medium conveyance unit.

The system controller 172 sends command signals to the respective sections in accordance with the determination signals outputted from a sensor 192. The sensor 192 shown in FIG. 8 represents sensors disposed in the respective sections of the inkjet recording apparatus 100, including paper feed sensors arranged at the transfer units for the recording medium 114 in the pressure drums 126a to 126d, temperature sensors arranged in the respective sections, a position determination sensor for determining the height position of the elevator mechanism 234 in the wiping unit 230, and so on.

Various control programs are stored in the program storage unit 190, and a control program is read out and executed in accordance with commands from the system controller 172. The program storage unit 190 may use a semiconductor memory, such as a ROM, EEPROM, or a magnetic disk, or the like. The program storage unit 190 may be provided with an external interface, and a memory card or PC card may also be used. Naturally, a plurality of these storage media may also be provided. The program storage unit 190 may also be combined with a storage device for storing operational parameters, and the like (not shown).

The motor driver 176 drives the motor 188 in accordance with commands from the system controller 172. In FIG. 8, the plurality of motors disposed in the respective sections of the inkjet recording apparatus 100 are represented by the reference numeral 188. For example, the motor 188 shown in FIG. 8 includes the motors driving the pressure drums 126a to 126d described with reference to FIG. 1, the motors driving the conveyance units in the paper supply unit 102 and the paper output unit 112.

The heater driver 178 is a driver that drives the heater 189 in accordance with commands from the system controller 172. In FIG. 8, the plurality of heaters disposed in the inkjet recording apparatus 100 are represented by the reference numeral 189. For example, the heater 189 shown in FIG. 8 includes the heaters in the paper preheating units 128 and 134 described with reference to FIG. 1, the heaters in the various drying units 132, 138, 142a and 142b, the heaters in the heating rollers 148a and 148b in the fixing unit 110.

The printing control unit 180 has a signal processing function for performing a variety of processing and correction operations for generating signals for print control from the image data within the memory 174 according to control of the system controller 172, and supplies the generated printing data (dot data) to the head driver 184. The required signal processing is implemented in the printing control unit 180, and the ejection amount and ejection timing of ink droplets in the head 50 are controlled through the head driver 184 based on the image data. As a result, the desired dot size and dot arrangement are realized.

The printing control unit 180 is provided with the image buffer memory 182, and data such as image data or parameters are temporarily stored in the image buffer memory 182 during image data processing in the printing control unit 180. The aspect illustrated in FIG. 8 is one in which the image buffer memory 182 accompanies the print control unit 180; however, the memory 174 may also serve as the image buffer memory 182. Also possible is an aspect in which the print control unit 180 and the system controller 172 are integrated to form a single processor.

In the inkjet recording apparatus 100, an image which appears to have a continuous tonal graduation to the human eye is formed by changing the droplet ejection density and the dot size of fine dots created by ink (coloring material), and therefore, it is necessary to convert the input digital image into a dot pattern which reproduces the tonal gradations of the image (namely, the light and shade toning of the image) as faithfully as possible. Therefore, original image data (RGB data) stored in the memory 174 is sent to the print control unit 180 through the system controller 172, and is converted to the dot data for each ink color by a half-toning technique, using a threshold value matrix, error diffusion, or the like, in the print control unit 180. The dot data thus generated is stored in the image buffer memory 182.

The head driver 184 outputs drive signals for driving the actuators 58 (see FIG. 4) corresponding to the nozzles 51 in the head 50, on the basis of the dot data supplied from the print controller 180 (in other words, the dot data stored in the image buffer memory 182). The head driver 184 may include a feedback control system for maintaining constant drive conditions for the head 50.

By supplying the drive signals output by the head driver 184 to the head 50, ink is ejected from the corresponding nozzles 51. An image is formed on the recording medium 114 by controlling ink ejection from the head 50 while conveying the recording medium 114 at a prescribed speed.

The image data captured by the in-line determination unit 144 serving as the print determination unit is inputted to the print controller 180. The in-line determination unit 144 reads in the image (or a test pattern) printed on the recording medium 114, performs various signal processing operations, and the like, and determines the print situation (presence/absence of ejection, variation in droplet ejection, optical density, and the like), and supplies these determination results to the print controller 180.

The print controller 180 implements various corrections with respect to the head 50, on the basis of the information obtained the in-line determination unit 144, according to requirements, and controls the respective units in association with the maintenance control unit 179 for carrying out maintenance operations with respect to the head 50.

The maintenance control unit 179 functions as a device which controls the maintenance operations for the head 50 by the maintenance unit 70 shown in FIGS. 6 and 7. In other words, the maintenance control unit 179 shown in FIG. 8 controls the movement of the head 50, the driving of the cleaning liquid pump 213 (see FIG. 7) in the cleaning liquid application unit 210 of the maintenance unit 70, the driving of conveyance of the web 231 in the wiping unit 230, the driving of the elevator mechanism 234, and the like, on the basis of command signals sent from the system controller 172.

### Description of Maintenance Operation

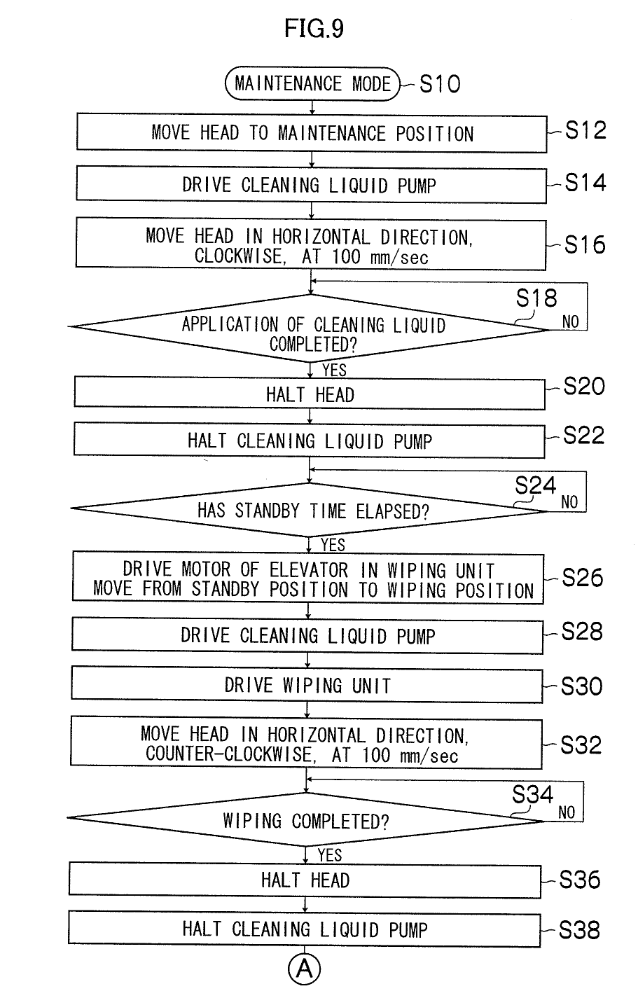

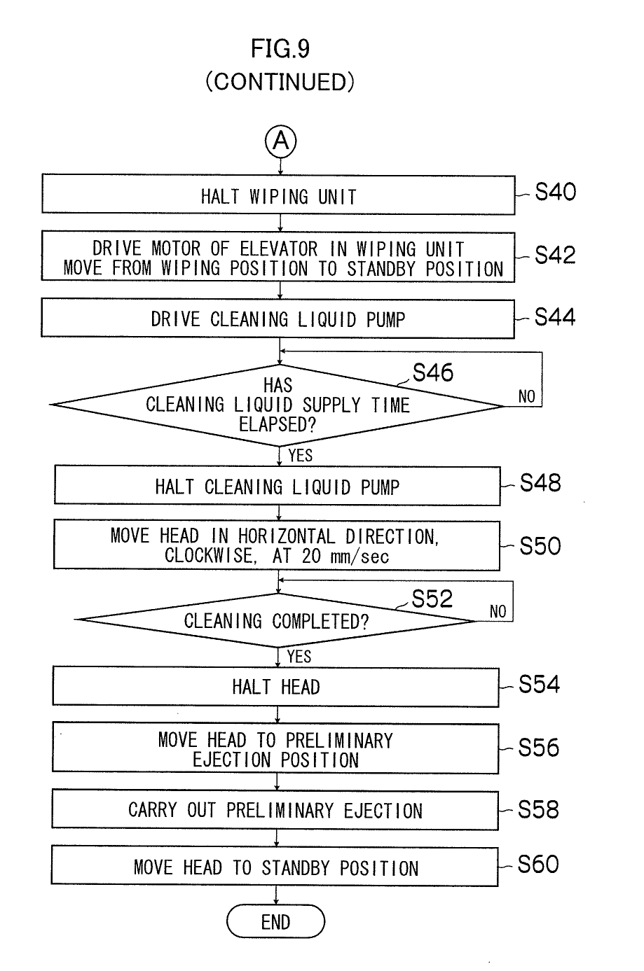

FIG. 9 is a flowchart showing a head maintenance sequence in the inkjet recording apparatus 100 according to the present embodiment.

When the apparatus transfers to maintenance mode (step S10), the head 50 is moved to a maintenance position (step S12). This maintenance position is an initial position where the maintenance operation is started, and in the present embodiment, is taken to be the image forming position P1 facing the pressure drum 126c. The maintenance position may also be a position where the head 50 is withdrawn above the surface of the pressure drum 126c from the image forming position P1 (an upward withdrawn position which increases the clearance between the nozzle surface 50A and the circumferential surface of the pressure drum 126c).

Thereupon, the cleaning liquid pump 213 is driven (step S14), and the cleaning liquid 216 is ejected from the cleaning liquid nozzles 214. In a state where the cleaning liquid 216 is continuously ejected from the cleaning liquid nozzle 214, the head 50 is moved in the horizontal direction (in the axial direction of the pressure drum 126c, and toward the maintenance unit 70), at a distance of 1 mm above the cleaning liquid nozzle 214, at a head movement speed of 100 mm/sec, whereby the cleaning liquid is applied to the nozzle surface 50A (step S16). The direction in which the motor is turned when the head 50 is moved horizontally in step S16 is taken to be the clockwise direction.

When the application of the cleaning liquid has been completed over the whole nozzle surface 50A of the head 50 (“yes” at step S18), the head 50 is halted (step S20), and the cleaning liquid pump 213 is halted (step S22).

Thereafter, in order to increase the effects of the cleaning liquid, a standby time is provided (step S24). Here, the standby time is taken to be 30 seconds. The cleaning liquid applied to the periphery of the adhering matter on the nozzle surface 50A enters into the interface between the adhering matter and the nozzle surface 50A and lowers the adhesive force of same. Furthermore, the cleaning liquid also dissolves the surface of the adhering matter and reduces the size of the adhering portion.

After a prescribed standby time period has elapsed (“yes” at step S24), the motor in the elevator mechanism 234 of the wiping unit 230 is driven so that the web cartridge 232 is moved from the standby position to the wiping position where the web 231 abuts against the nozzle surface 50A of the head 50 (step S26).

Thereupon, the cleaning liquid pump 213 is driven (step S28) and the cleaning liquid is ejected from the cleaning liquid nozzle 214, in addition to which the web 231 of the wiping unit 230 is fed (step S30), while the head 50 is moved horizontally in the opposite direction (the direction toward the pressure drum 126c) (step S32), and the wiping cleaning operation is carried out while reapplying the cleaning liquid.

In this way, by applying the cleaning liquid before the wiping, a beneficial effect is obtained in raising the ability of removing adhering matter. Furthermore, this cleaning liquid acts as a lubricant which wets the nozzle surface 50A before wiping, and thus makes it possible to prevent scratches, and the like, when the nozzle surface 50A is wiped with the web 231. The web 231 in the present embodiment uses a cloth made of polyester fibers.

After wiping the whole of the nozzle surface 50A (“yes” at step S34), the head 50 is halted (step S36), the cleaning liquid pump 213 is halted (step S38), and the feeding of the web 231 is also halted (step S40).

Thereupon, the motor in the elevator mechanism 234 of the wiping unit 230 so that the wiping unit 72 is withdrawn to the position where it does not touch the head 50 (standby position) (step S42).

By means of the steps up to this point, the adhering matter on the nozzle surface 50A has been removed. However, a wiping trace of the web 231 (small droplets of the cleaning liquid) may be left in a line shape in the wiping direction, on the nozzle surface 50A. If this wiping trace occurs in the vicinity of the nozzles 51, then it may give rise to flight direction abnormalities of the ink droplets.

Therefore, in the present embodiment, the finishing rinse (steps S44 to S54) is carried out after step S42. The finishing rinse may employ a method which creates a pool of cleaning liquid between the cleaning liquid nozzle 214 and the nozzle surface 50A of the head 50, as stated in the first embodiment described above, or a mode where the cleaning liquid is caused to flow from the cleaning liquid nozzles 214, as in the second embodiment. In the former case, there is a merit in that the wiping trace can be removed by using a small amount of cleaning liquid. In the latter case, it is possible to clean the wiping trace without running out of the cleaning liquid, even in a long head.

The flowchart in FIG. 9 shows a case of the first embodiment. Firstly, the cleaning liquid pump 213 is driven at low speed (step S44), and by waiting for a prescribed time period (cleaning liquid supply time) to elapse (step S46), the meniscus of cleaning liquid (the convex upper surface of the cleaning liquid pillar 217 described in FIG. 7) is created at the top end portion of the cleaning liquid nozzle 214. The cleaning liquid pump 213 is halted after the prescribed time has elapsed (step S48), and in this state, the head 50 is moved in the horizontal direction and passed over the meniscus, at a slow speed (here, 20 mm/sec) (step S50).

In this case, due to the surface tension of the cleaning liquid, when the meniscus makes contact with the head 50, the meniscus is not broken down and the wiping trace on the nozzle surface 50A is washed away while preserving the meniscus shape. By this means, it is possible to remove the wiping trace without leaving any droplets of the cleaning liquid on the nozzle surface 50A.

When the cleaning (finishing rinse) has been completed over the whole of the nozzle surface 50A of the head 50 (“yes” at step S52), the head 50 is halted (step S54).

Thereupon, according to requirements, the head 50 is moved to a preliminary ejection position (in the present embodiment, the position facing the nozzle cap 76 described with reference to FIG. 6) (step S56), and preliminary ejection is carried out toward the nozzle cap 76 (step S58). Then, the head 50 is moved to a prescribed standby position (step S60), and the maintenance mode is terminated.

### <Another Maintenance Sequence>

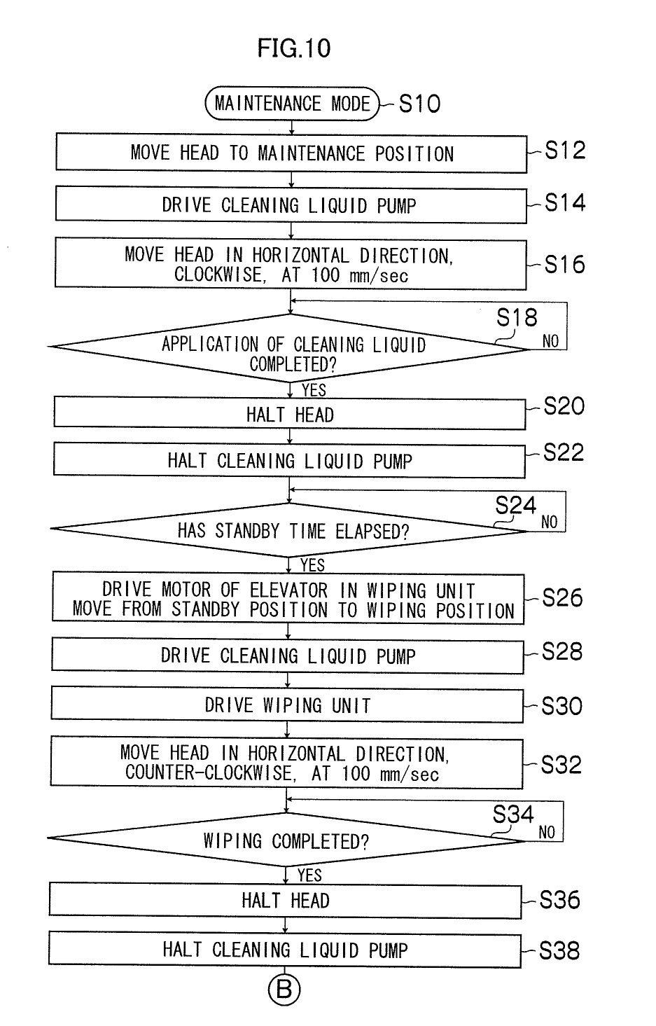

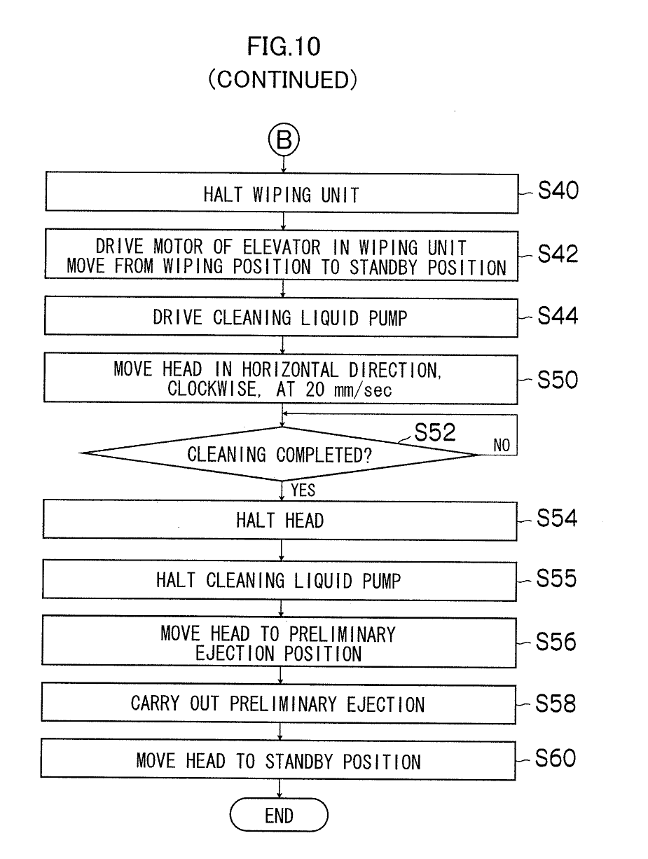

FIG. 10 is a flowchart of a case of the second embodiment. In FIG. 10, the steps which are the same as or similar to the flowchart shown in FIG. 9 are denoted with the same step numbers and description thereof is omitted here.

Up to step S44 in the flowchart in FIG. 10, the sequence is the same as the flowchart in FIG. 9. In the case of FIG. 10, in the finishing rinse process, the cleaning liquid pump 213 is driven (step S44), and the cleaning liquid is sprayed from the cleaning liquid nozzle 214. In this state, the head 50 is moved in the horizontal direction and passed above the cleaning liquid nozzle 214 at a slow speed of 20 mm/sec (step S50).

By this means, the wiping trace on the nozzle surface 50A is washed away and the wiping trace can be removed without leaving any droplets of the cleaning liquid on the nozzles surface 50A.

When the cleaning (finishing rinse) has been completed over the whole of the nozzle surface 50A of the head 50 (“yes” at step S52), the head 50 is halted (step S54), and the cleaning liquid pump 213 is halted (step S55). The subsequent processing (steps S56 to S60) is similar to the flowchart in FIG. 9.

### Third Embodiment of Cleaning Apparatus

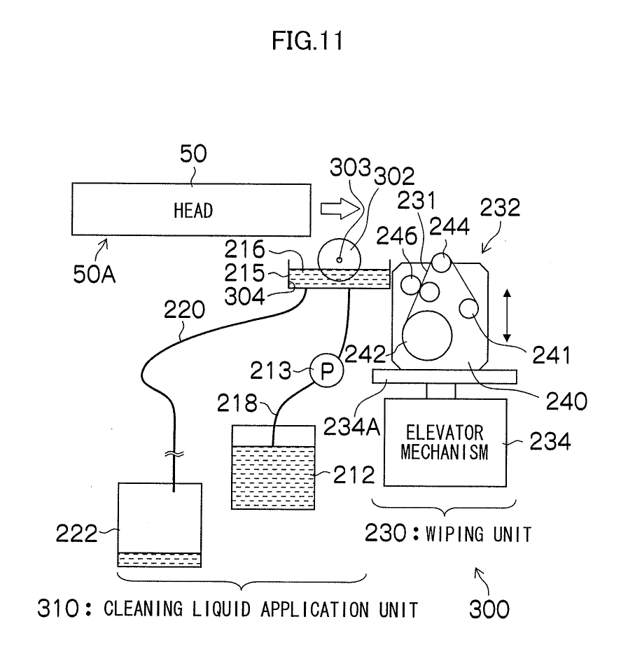

FIG. 11 is a principal schematic drawing of a cleaning apparatus 300 employed in the maintenance unit 70, according to a third embodiment. In FIG. 11, the elements which are the same as or similar to the composition described with reference to FIG. 7 are denoted with the same reference numerals, and description thereof is omitted here. Furthermore, FIG. 11 does not depict the composition of the nozzle cap 76, and the like.

The cleaning apparatus 300 shown in FIG. 11 employs a mode in which the cleaning liquid is applied to the nozzle surface 50A of the head 50 by using a roller, which is not in contact with the nozzle surface 50A, instead of the cleaning liquid nozzle 214 of the cleaning liquid application unit 210 in the cleaning apparatus 200 described with reference to FIG. 7. More specifically, the cleaning apparatus 300 in FIG. 11 has a cleaning liquid application unit 310 including a cleaning liquid application roller 302 and a cleaning liquid receptacle 304.

The cleaning liquid 216 is supplied to the cleaning liquid receptacle 304 from the cleaning liquid tank 212, so that a pool of predetermined amount of cleaning liquid 216 is formed in the cleaning liquid receptacle 304. The cleaning liquid application roller 302 has a rotational axle 303 disposed in a direction perpendicular to the movement direction of the head 50 (the direction of the rotational axle 82 of the pressure drum 126c, see FIG. 6). The cleaning liquid application roller 302 is disposed in a position near the nozzle surface 50A so as to maintain a suitable clearance for avoiding contact with the nozzle surface 50A when the roller 302 faces the nozzle surface 50A of the head 50.

The interval between the nozzle surface 50A and the circumferential surface of the cleaning liquid application roller 302 when the cleaning liquid application roller 302 faces the nozzle surface 50A is sufficient to enable a cleaning liquid layer to be maintained by filling the interval with the cleaning liquid. Similarly to the first embodiment, the suitable interval is designed in accordance with the properties of the cleaning liquid (e.g., viscosity and surface tension), and the head movement speed, and the like.

A portion of the lower side of the cleaning liquid application roller 302 is immersed in the cleaning liquid 216 standing in the cleaning liquid receptacle 304. The cleaning liquid 216 is taken up onto the circumferential surface of the cleaning liquid application roller 302 due to the rotation of the cleaning liquid application roller 302, thereby forming a cleaning liquid film (cleaning liquid layer) on the circumferential surface of the cleaning liquid application roller 302.

For the cleaning liquid application roller 302, it is possible to use a rubber roller made of silicone, urethane, ethylene propylene diene rubber (EPDM), or the like, a plastic roller made of polyacetal (POM) or the like, a metal roller made of stainless steel (SUS), or the like. In particular, it is suitable to use a silicone roller or POM roller. The direction of rotation of the cleaning liquid application roller 302 is set to the same direction (forward direction) as the direction of movement of the head 50 during cleaning.

A plurality of the cleaning liquid application rollers 302 may be provided respectively to the ink ejection heads 140C, 140M, 140Y and 140K of the respective ink colors, or a single common roller may be used for all of the heads. In the latter case, a cleaning liquid application roller having the circumferential surface of an arc shape along the axial direction of the roller is used, so as to follow the respective nozzle surfaces of the ink ejection heads 140C, 140M, 140Y and 140K which are disposed on an arc following the circumferential surface of the pressure drum 126c described with reference to FIG. 1.

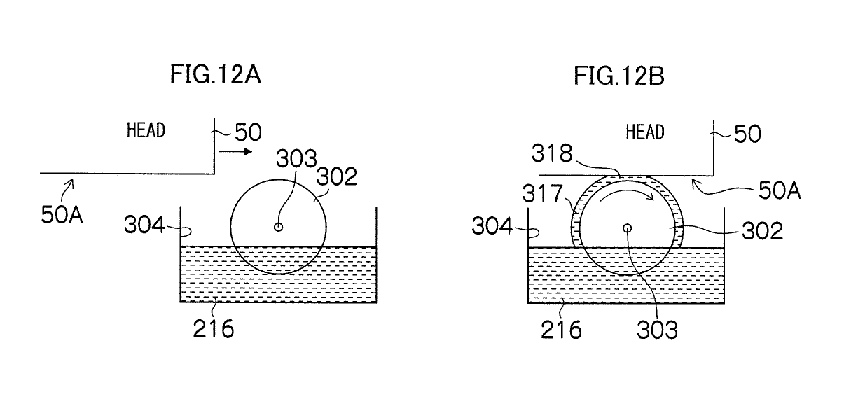

FIGS. 12A and 12B are schematic drawings showing the action of the cleaning liquid application roller 302. When the cleaning liquid is supplied to the nozzle surface 50A of the head 50 by the cleaning liquid application roller 302, as shown in FIGS. 12A and 12B, the head 50 is moved in the horizontal direction and passed above the cleaning liquid application roller 302. In this case, by rotating the cleaning liquid application roller 302, which is partially immersed in the cleaning liquid 216, the cleaning liquid film 317 is formed on the circumferential surface of the cleaning liquid application roller 302, and the nozzle surface 50A makes contact with the cleaning liquid film 317.

More specifically, the cleaning liquid application roller 302 itself does not make contact with the nozzle surface 50A of the head 50, but rather the cleaning liquid film 317 taken up by the rotation of the cleaning liquid application roller 302 makes contact with the nozzle surface 50A. In this way, the cleaning liquid layer 318 which fills in the gap between the nozzle surface 50A of the head 50 and the cleaning liquid application roller 302 is created.

In the third embodiment also, similar results to those shown in Table 1 in the first embodiment are obtained, and if the linear speed is fast, then the cleaning liquid layer 318 breaks down and droplets of the cleaning liquid adhere to the nozzle surface 50A. If the head movement speed was 20 mm/sec or lower, then satisfactory results were obtained.

If the composition of the third embodiment is adopted, then before or during wiping by the web 231, the movement speed of the head 50 and the rotation of the cleaning liquid application roller 302 are controlled so as to apply the cleaning liquid to the nozzle surface 50A, thereby lubricating the surface. On the other hand, after wiping the web 231, in the finishing rinse step for removing the wiping trace, the movement of the head 50 and the rotation of the cleaning liquid application roller 302 are performed at a sufficiently slow speed to prevent breakdown of the meniscus of the cleaning liquid layer 318. By this means, it is possible to remove the wiping trace without leaving the cleaning liquid on the nozzle surface 50A.

### THIRD EXAMPLE

It was possible to form a cleaning liquid film of 0.5 mm thick on the cleaning liquid application roller in a case where the cleaning liquid application roller was made of POM, the cleaning liquid was DEGmBE having the viscosity of 20 cP, the diameter of the cleaning liquid application roller was 40 mm, and the rotational speed of the cleaning liquid application roller was 600 rpm.

Furthermore, by passing the head so as to make contact with a portion of the cleaning liquid film, the cleaning liquid was supplied to the nozzle surface of the head without making the cleaning liquid application roller contact with the nozzle surface of the head, and the wiping trace of the nozzle surface was cleaned away. As a result, the wiping trace was removed from the nozzle surface, no cleaning liquid was left on the nozzle surface, and good cleaning effects were obtained.

### Beneficial Effects of the Embodiments

In any one of the first to third embodiments described above, it is possible to wash way the wiping residue (wiping traces) which occur after wiping by the web 231, and hence the wiping residue can be removed effectively.

Thus, ejection direction errors caused by the wiping residue, such as the wiping traces, are prevented and therefore the reliability of ejection can be improved. Consequently, it is possible to improve the quality of the output image.

Furthermore, in the embodiments described above, the composition is adopted in which adhering matter is removed by sliding the web 231 (wiping member) over the nozzle surface 50A, whereupon the wiping residue is removed by the cleaning liquid, thereby making it possible both to remove adhering matter and to clean the nozzle surface.

### First Modification of the Embodiments

In the respective embodiments described above, the device that applies the cleaning liquid to the nozzle surface 50A of the head 50 (the cleaning liquid nozzle 214 and the cleaning liquid application roller 302) before the wiping also serves as the cleaning liquid supply device during the finishing rinse, but it is also possible to separately provide a cleaning liquid application device for the application before the wiping and a cleaning liquid supply device for the finishing rinse. For instance, in the first embodiment, the cleaning apparatus 200 may be provided with the cleaning liquid nozzle for the application before the wiping and the cleaning liquid nozzle for the finishing rinse separately.

### Second Modification of the Embodiments

In the respective embodiments described above, the same cleaning liquid is used for the wiping operation and for the finishing rinse, but it is also possible to use different cleaning liquids. For example, in the case of the finishing rinse in the first embodiment, it is desirable to use a liquid having higher surface tension, in order to maintain the meniscus of the cleaning liquid pillar 217 (without breaking the meniscus) while dragging the cleaning liquid pillar 217 relatively with respect to the nozzle surface. Consequently, it may be desirable to adopt a mode in which the cleaning liquid used for the finishing rinse is a liquid having higher surface tension than the cleaning liquid used for the wiping operation.

By raising the surface tension of the cleaning liquid used in the finishing rinse, breakdown of the meniscus becomes less liable to occur in respect to the head movement speed (relative speed), and hence the speed can be raised.

### Third Modification of the Embodiments

In the respective embodiments described above, the finishing rinse is carried out to remove the wiping traces after the wiping operation by the web 231, but it is also possible to carry out a similar cleaning step to the finishing rinse described above, regardless of whether or not a wiping operation is implemented.

### Fourth Modification of the Embodiments

In the respective embodiments described above, the cloth web 231 is used as the wiping member, but a mode which uses a blade instead of or in conjunction with this is also possible.

### Fifth Modification of the Embodiments

In the respective embodiments described above, the cleaning apparatus for cleaning the ink ejection head has been explained, but a similar composition can also be applied to a cleaning apparatus for cleaning the permeation suppression agent ejection head 130 described with reference to FIG. 1, and a cleaning apparatus for cleaning the treatment liquid ejection head 136.

Example of Application to Other Apparatus Compositions

The embodiments described above relate to examples of application to the inkjet recording apparatus for printing, but the scope of application of the present invention is not limited to this. For instance, it can also be applied widely to other apparatuses which obtain various shapes and patterns by using a liquid functional material, such as a wiring printing apparatus which prints a wiring pattern for an electronic circuit, or manufacturing apparatuses for various devices, a resist printing apparatus using resin liquid as a functional liquid for ejection, or a fine structure forming apparatus which forms a fine structure by using a material deposition substance.

### Appendix

As has become evident from the detailed description of the embodiments given above, the present specification includes disclosure of various technical ideas below.

It is preferable that a cleaning apparatus which cleans a nozzle surface of a liquid ejection head, comprises: a cleaning liquid supply device which supplies cleaning liquid to the nozzle surface while being not in contact with the nozzle surface; a movement device which moves the cleaning liquid supply device and the liquid ejection head relatively to each other; a liquid layer formation control device which causes the cleaning liquid supply device to supply a prescribed amount of the cleaning liquid to form a layer of the cleaning liquid that fills in a space between the cleaning liquid supply device and the nozzle surface; and a movement control device which controls the movement device so as to move the cleaning liquid supply device and the liquid ejection head relatively to each other at a relative speed in which a meniscus is not broken down, the meniscus being of the layer of the cleaning liquid in a portion of the layer of the cleaning liquid that makes contact with the nozzle surface.

For example, the liquid amount supplied from the cleaning liquid supply device is adjusted to form the cleaning liquid layer sufficient to fill in the space between the cleaning liquid supply device and the nozzle surface, and by bringing the cleaning liquid layer and the nozzle surface of the liquid ejection head into mutual contact, the cleaning liquid is filled in the space between the cleaning liquid supply device and the nozzle surface.

Thus, the cleaning liquid layer which fills in the space between the nozzle surface and the cleaning liquid supply device is formed and relative movement is performed so as to not to break the meniscus of the cleaning liquid layer.

Preferably, the relative speed is not higher than 20 mm/sec.

It is desirable that the relative speed which does not break down the meniscus of the cleaning liquid layer that makes contact with the nozzle surface is 20 mm/sec or lower. Provided that the relative speed is a low speed which satisfies this condition, the meniscus of the cleaning liquid layer is maintained and droplets of the cleaning liquid do not remain on the nozzle surface.

Preferably, the cleaning liquid supply device includes a plurality of nozzles which emit the cleaning liquid toward the nozzle surface of the liquid ejection head.

There is a mode which uses the plurality of nozzles as the device which supplies the cleaning liquid to the nozzle surface in the non-contact fashion. In this case, it is also possible to adopt a mode which forms pillars of the cleaning liquid by causing the cleaning liquid to bulge out from the nozzles, or a mode which creates a continuous flow of the cleaning liquid by spraying the cleaning liquid from nozzles.

Preferably, the liquid layer formation control device includes a liquid amount control device which controls an amount of the cleaning liquid emitted from each of the nozzles of the cleaning liquid supply device; and the liquid amount control device controls the amount of the cleaning liquid emitted from each of the nozzles in such a manner that a pillar of the cleaning liquid is formed by causing the cleaning liquid to bulge out from each of the nozzles, and the movement control device controls the movement device in such a manner that the nozzle surface of the liquid ejection head is brought in contact with a meniscus of the pillar of the cleaning liquid while maintaining the meniscus of the pillar of the cleaning liquid, such that the layer of the cleaning liquid is formed between the cleaning liquid supply device and the nozzle surface.

According to this mode, it is possible to raise the nozzle surface cleaning effects while suppressing the amount of cleaning liquid used (cleaning liquid consumption).

It is also preferable that the liquid layer formation control device includes a liquid amount control device which controls an amount of the cleaning liquid emitted from each of the nozzles of the cleaning liquid supply device; and the liquid amount control device controls the amount of the cleaning liquid emitted from each of the nozzles in such a manner that the cleaning liquid is sprayed from each of the nozzles, and the movement control device controls the movement device in such a manner that the nozzle surface of the liquid ejection head is brought in contact with the sprayed cleaning liquid, such that the layer of the cleaning liquid is formed between the cleaning liquid supply device and the nozzle surface.

According to this mode, it is possible to continuously supply fresh cleaning liquid between the cleaning liquid supply device and the nozzle surface, and the cleaning capability of the cleaning liquid can be maintained. Furthermore, even in the case of a long liquid ejection head having a plurality of nozzles, it is possible to supply the cleaning liquid without running out of the cleaning liquid, and therefore application to a long head is simple to achieve.

Preferably, the cleaning liquid supply device includes a rotating roller.

By forming a film of the cleaning liquid on the circumferential surface of the roller and performing relative movement in such a manner that the nozzle surface of the liquid ejection head makes contact with the cleaning liquid film, it is possible to supply the cleaning liquid to the nozzle surface in a non-contact fashion.

Preferably, the cleaning apparatus further comprises a wiping device which performs a wiping operation in which the wiping device wipes the nozzle surface of the liquid ejection head by sliding over the nozzle surface.

A cleaning step of relatively moving the cleaning liquid layer filled in the space between the cleaning liquid supply device and the nozzle surface, with respect to the nozzle surface, can be used in combination with a step of wiping and cleaning by means of the wiping device.

Preferably, after the wiping operation by the wiping device, the layer of the cleaning liquid is formed, and then the cleaning liquid supply device and the liquid ejection head are moved relatively to each other at the relative speed.

A desirable mode is one which carries out cleaning by relatively moving the cleaning liquid layer, consecutively after the wiping operation.

Preferably, in the wiping operation by the wiping device, liquid same with the cleaning liquid is used to lubricate the nozzle surface of the liquid ejection head.

By making common use of the cleaning liquid, it is possible to simplify the apparatus composition.

Preferably, the cleaning liquid supply device also serves as a device which lubricates the nozzle surface of the liquid ejection head in the wiping operation by the wiping device.

It is also possible to adopt a composition where the cleaning liquid supply device also serves as a device for depositing (applying) cleaning liquid to the nozzle surface, whereby the apparatus having a simple composition can be obtained.

It is also preferable that a liquid ejection apparatus comprises: the liquid ejection head having the nozzle surface in which nozzles for ejecting liquid toward an ejection receiving medium are formed; and the above-described cleaning apparatus.

One example of the liquid ejection apparatus is an inkjet recording apparatus (image forming apparatus) which forms a desired image by ejecting colored inks onto a recording medium.

It is also preferable that a method of cleaning a nozzle surface of a liquid ejection head comprises the steps of: using a cleaning liquid supply device to supply cleaning liquid to the nozzle surface, the cleaning liquid supply device being not in contact with the nozzle surface; forming a layer of the cleaning liquid which fills in a space between the cleaning liquid supply device and the nozzle surface by supplying a prescribed amount of the cleaning liquid from the cleaning liquid supply device; and moving the cleaning liquid supply device and the liquid ejection head relatively to each other at a relative speed in which a meniscus is not broken down, the meniscus being of the layer of the cleaning liquid in a portion of the layer of the cleaning liquid that makes contact with the nozzle surface.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed:

1. A cleaning apparatus which cleans a nozzle surface of a liquid ejection head, the apparatus comprising:
a cleaning liquid supply device which supplies cleaning liquid to the nozzle surface while being not in contact with the nozzle surface;
a movement device which moves the cleaning liquid supply device and the liquid ejection head relatively to each other;
a liquid layer formation control device which causes the cleaning liquid supply device to supply a prescribed amount of the cleaning liquid to form a layer of the cleaning liquid that fills in a space between the cleaning liquid supply device and the nozzle surface;
a movement control device which controls the movement device so as to move the cleaning liquid supply device and the liquid ejection head relatively to each other at a relative speed in which a meniscus is not broken down, the meniscus being of the layer of the cleaning liquid in a portion of the layer of the cleaning liquid that makes contact with the nozzle surface; and
a wiping device which performs a wiping operation in which the wiping device wipes the nozzle surface of the liquid ejection head by sliding over the nozzle surface.

2. The cleaning apparatus as defined in claim 1, further comprising a wiping control device which causes the cleaning liquid supply device to perform a cleaning liquid application operation in which the cleaning liquid is applied onto the nozzle surface of the liquid ejection head, and then causes the wiping device to perform the wiping operation in which the wiping device wipes the nozzle surface of the liquid ejection head on which the cleaning liquid has been applied by the cleaning liquid application operation.

3. The cleaning apparatus as defined in claim 2, wherein the wiping control device waits for a prescribed standby time to cause the wiping device to perform the wiping operation after causing the cleaning liquid supply device to perform the cleaning liquid application operation.

4. The cleaning apparatus as defined in claim 1, wherein after the wiping operation by the wiping device, the layer of the cleaning liquid is formed, and then the cleaning liquid supply device and the liquid ejection head are moved relatively to each other at the relative speed.

5. A liquid ejection apparatus, comprising:
the liquid ejection head having the nozzle surface in which nozzles for ejecting liquid toward an ejection receiving medium are formed; and
the cleaning apparatus as defined in claim 1.

6. A method of cleaning a nozzle surface of a liquid ejection head, comprising the steps of:
using a cleaning liquid supply device to supply cleaning liquid to the nozzle surface, the cleaning liquid supply device being not in contact with the nozzle surface;
wiping the nozzle surface of the liquid ejection head by sliding a wiping device over the nozzle surface;
forming a layer of the cleaning liquid which fills in a space between the cleaning liquid supply device and the nozzle surface by supplying a prescribed amount of the cleaning liquid from the cleaning liquid supply device; and
moving the cleaning liquid supply device and the liquid ejection head relatively to each other at a relative speed in which a meniscus is not broken down, the meniscus being of the layer of the cleaning liquid in a portion of the layer of the cleaning liquid that makes contact with the nozzle surface.

7. The method as defined in claim 6, further comprising the step of applying the cleaning liquid onto the nozzle surface of the liquid ejection head by the cleaning liquid supply device,
wherein in the step of wiping the nozzle surface of the liquid ejection head, the wiping device wipes the nozzle surface on which the cleaning liquid has been applied in the step of applying the cleaning liquid.

8. The method as defined in claim 7, wherein the step of wiping the nozzle surface of the liquid ejection head is carried out after a prescribed standby time has been elapsed after the step of applying the cleaning liquid.

9. The method as defined in claim 6, wherein the step of forming the layer of the cleaning liquid and the step of moving the cleaning liquid supply device and the liquid ejection head relatively to each other are carried out after the step of wiping the nozzle surface of the liquid ejection head.
